(19) United States
(12) Patent Application Publication
(10) Pub. No.: US 2002/0055905 A1
(43) Pub. Date: May 9, 2002

(54) System and process for securitizing reverse mortgage loans

(76) Inventors: Shekar Jannah, Forest, VA (US); Burt Hazelwood, Richmond, VA (US)

Correspondence Address: Jonathan D. Link, Hunton & Williams, Suite 1200, 1900 K Street, N.W., Washington, DC, 20006, US

(21) Appl. No.: 09/950,009

(22) Filed: Sep. 12, 2001

Related U.S. Application Data
(60) Provisional application No. 60/231,554, filed on Sep. 11, 2000.

(51) Int. Cl. G06F 17/60

(52) U.S. Cl. 705/38

(57) ABSTRACT

A process and system for securitization of a reverse mortgage loan are provided, wherein a loan is made to a borrower. The borrower uses a real property, such as a home, as collateral for the loan. The amount of repayment is based on multiple repayment calculation components. The system and process comprise generating a sale of the reverse mortgage loan from a loan processing component to a securitization creating component. The securitization creating component generates a securitization note based on the reverse mortgage loan, including such factors as the age and sex of the borrower.

### FIELD OF THE INVENTION

The present invention relates generally to systems and methods for securitizing reverse mortgage loans and more particularly for reverse mortgage loans having real property as collateral.

### BACKGROUND OF THE INVENTION

Many people invest money for purposes of retirement. Investment vehicles such as savings accounts, individual retirement accounts (IRAs), 401(k) accounts, and others, provide opportunities for a person to plan for retirement or other expenses. Many of these investment vehicles, such as certificates of deposit (CDs), IRAs, or 401(k) accounts, are not liquid or freely convertible into cash. For many people, whether they have other investment vehicles or not, a home or real property may be an asset in which such persons have a large equity interest built up over time.

However, many people are unable to access the equity built-up in their homes. People who are at or near retirement may not be able TO or want to sell their home to access accumulated equity. A standard loan using the house as collateral, such as a home equity loan, may not be practical for the retiree with little or no income, as a retiree may not be able to make periodic repayments on a conventional loan.

It is known in the financial industry that there are various means for securitizing various types of assets to allow them to be bought and sold in a market. For example, auto loans, mortgages, leases, and other assets with associated cash flows may be securitized according to the cash flow of the particular asset and the risk associated with that asset. Securitization may be desirable to provide liquidity. However, some financial products may be difficult to securitize. Investors may be unfamiliar with the asset upon which a securitized note is based. This unfamiliarity may affect the purchase price investors are willing to pay, which may adversely affect the issuer of the securitized note.

It may be desirable to optimize the return structure of a loan and/or the securitized note(s) based on the loan. However, setting parameters on a loan and/or a securitized note based on the value of real property may be difficult, as the lender issuing the loan may have limited experience to determine an expected return structure for the loan.

These and other drawbacks exist.

### SUMMARY OF THE INVENTION

One feature of the present invention is to overcome these and other drawbacks in existing systems and methods.

A need is recognized for issuing a reverse mortgage loan to a borrower that allows real property to be used as collateral for the loan.

Another feature of the invention is to provide a system and methodology for securitizing reverse mortgage loans.

It is also desirable to provide a system and process for optimizing an expected return schedule for a reverse mortgage loan and/or a securitized note.

To achieve this invention, as embodied and broadly described herein, a process for providing a loan secured by real property comprises the steps of issuing a lump sum loan amount to an owner of real property, the loan secured by the real property of the owner and having a principal amount, an interest amount and a payoff amount where the owner does not make any installment payments toward repayment of the principal amount or towards repayment of the interest amount accrued until a termination date of the loan; and receiving a payment corresponding to the payoff amount of the loan on the termination date of the loan, the payoff amount being equal to the principal amount and the interest amount accrued during a term of the loan, and where the interest amount accrued is calculated based on a repayment schedule having at least one repayment calculation component.

In another aspect, a process for providing a loan secured by an asset comprises the steps of issuing a lump sum loan amount to an owner of the asset, the loan secured by the asset of the owner and having a principal amount, an interest amount and a payoff amount where the owner does not make an installment payment toward repayment of the principal amount towards repayment of the interest amount accrued until a termination date of the loan; and receiving a payment corresponding to the payoff amount of the loan on the termination date of the loan, the payoff amount being equal to the principal amount and the interest amount accrued during a term of the loan, and where the interest amount accrued is calculated based on a repayment schedule having a plurality of repayment calculation components.

In a further aspect, the invention comprises a system for providing a loan secured by real property, the loan having a principal amount, an interest amount and a payoff amount, where the system comprises at least one borrower receiving at least one lump sum loan amount, where the loan is secured by the real property of the at least one borrower, and the at least one borrower does not make any installment payment toward repayment of the principal amount, or toward repayment of the interest amount accrued until a termination date of the loan; and at least one lender component issuing the at least one lump sum loan amount and receiving a payment corresponding to the payoff amount of the loan on the termination date of the loan, the payoff amount being equal to the principal amount and the interest amount accrued during a term of the loan, and wherein the amount accrued is calculated based on a repayment schedule having at least one repayment calculation component.

Another aspect of the invention involves a system for providing a loan secured by an asset, the loan having a principal amount, an interest amount, and a payoff amount, where the system comprises at least one borrower receiving at least one lump sum loan amount, where the loan is secured by the asset of the at least one borrower, and the at least one borrower does not make any installment payment toward repayment of the principal amount or toward repayment of the interest amount accrued until a termination date of the loan; and at least one lender component issuing the at least one lump sum loan amount and receiving a payment corresponding to the payoff amount of the loan on the termination date of the loan, the payoff amount being equal to the principal amount and the interest amount accrued during a term of the loan, and wherein the amount accrued is calculated based on a repayment schedule having a plurality of repayment calculation components.

In a further aspect, a system for securitizing a loan having a principal amount, an interest amount and a payoff amount, comprises a lender component for issuing at least one loan secured by real property of a borrower, wherein: a) no installment payment towards repayment of the principal amount or toward repayment of the interest amount accrued is required until a termination date of the at least one loan; b) the payoff amount is equal to the principal amount and the interest amount accrued during a term of the at least one loan; and c) the interest amount accrued during the term of the loan is calculated based on a repayment schedule having a plurality of repayment calculation components; and a securitization component for issuing at least one securitized note based on the at least one loan.

In a further aspect, a process for securitizing a loan having a principal amount, an interest amount and a payoff amount, comprises issuing at least one loan to a borrower where: a) the at least one loan is secured by real property; b) no installment payment toward repayment of the principal amount or toward repayment of the interest amount accrued is required until a termination date of the at least one loan; and c) the amount accrued during the term of the loan is calculated based on a repayment schedule having a plurality of repayment calculation components; and issuing at least one securitized note based on the at least one loan.

In an additional aspect, a process for optimizing an expected return structure on a loan and at least one securitized note based on the loan, the loan having a principal amount, an interest amount, and payoff amount, the process comprising receiving borrower information, where the borrower information comprises information related to a borrower receiving the loan; receiving optimization constraints, where the solver constraints comprise information related to mathematical calculations of the expected return structure; receiving solver constraints, where the solver constraints comprise information to mathematical calculations of the expected return structure; and generating the expected return structure based in part on the borrower information, the optimization constraints and the solver constraints.

A further aspect involves a system for optimizing an expected return structure on a loan and at least one securitized note based on the loan, the loan having a principal amount, an interest amount and a payoff amount, where the system comprises a receiver module for receiving: a) borrower information related to a borrower receiving the loan; b) optimization constraints comprising information related to the expected return structure; and c) receiving solver constraints comprising information relate to the mathematical calculations for arriving at the expected return structure; and a processor module for generating the expected return structure based in part on the borrower information, the optimization constraints and the solver constraints.

Other objects and advantages exist for the present invention.

### BRIEF DESCRIPTION OF THE DRAWINGS

FIG. 1 is a schematic diagram illustrating a system for securitizing a reverse mortgage loan according to an embodiment of the invention.

FIG. 2 is a flowchart illustrating a process for issuing and securitizing a reverse mortgage loan according to an embodiment of the invention.

FIG. 3 is a chart illustrating a repayment schedule of a reverse mortgage loan according to an embodiment of the invention.

FIG. 4 is a flowchart illustrating a process for generating an expected return schedule according to an embodiment of the invention.

FIG. 5 is an example of one possible structure for a graphic user interface for securitization of reverse mortgage loans according to one embodiment of the invention.

### DETAILED DESCRIPTION OF THE PREFERRED EMBODIMENTS

The present invention is described in relation to a system and process for the issuance and securitization of reverse mortgage loan. Nonetheless, the characteristics and parameters pertaining to the systems and methods may be applicable to securitizations of other financial instruments and loans.

The present invention relates to reverse mortgage loans which enable a home owner to access the equity in his/her home. Further, this reverse mortgage loan may be made to a home owner while providing an option of delaying payment until the home is sold. Further, the present invention enables a lender to securitize the reverse mortgage loan, thereby providing the lender with flexibility and increased liquidity for running its business. Additionally, an optimization tool is provided in connection with the reverse mortgage loan, enabling the borrower/home owner to optimize returns on both the reverse mortgage loan and the securitized reverse mortgage loan. Various aspects of the present invention will now be described in greater detail below.

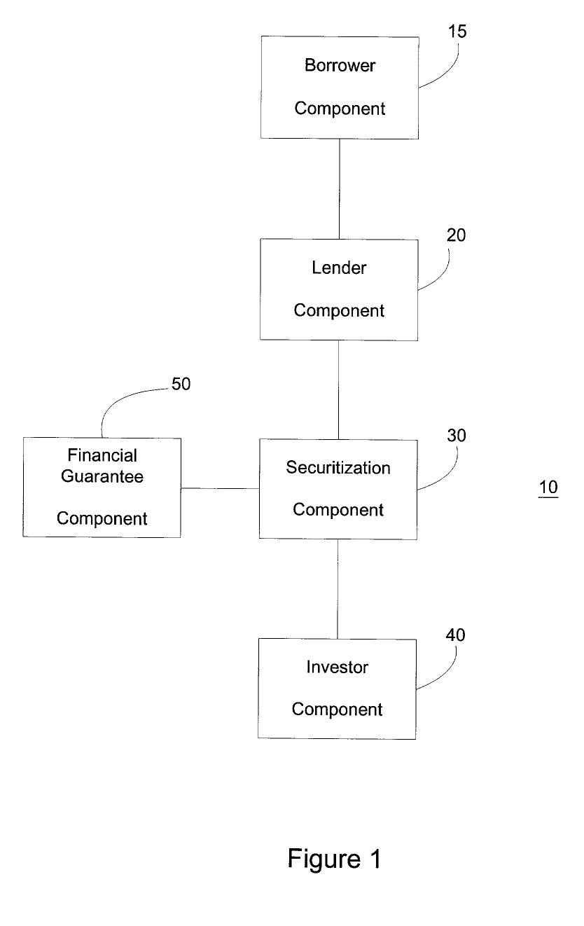

FIG. 1 is a schematic diagram illustrating a system 10 for securitizing a reverse mortgage loan according to an embodiment of the invention. System 10 includes one or more borrowers 15, a lender component 20, a securitization component 30, an investor component 40, and a financial guarantee component 50. Other components may also be included. Although only one of each component of system 10 is shown in FIG. 1, it should be understood that the present invention may be performed using any number of each component. Pursuant to system 10, one or more borrowers 15 may request one or more reverse mortgage loans from the lender component 20. Lender component 20 may be an insurance company, a bank, an investment company, a mortgage lender, trust, or other type of financial or corporate entity which lends funds. In obtaining the loan from lender component 20, the borrower 15 offers his/her home as collateral. According to an embodiment of the invention, other assets, such as real property (e.g., land), may also be pledged as collateral. Lender component 20 aggregates the reverse mortgage loans and sells them to securitization component 30. The sale of the reverse mortgage loans may be in exchange for cash and/or an equity interest in lender component 20. According to an embodiment of the invention, in selling the reverse mortgage loans to securitization component 30, lender component 20 may agree to continue servicing the reverse mortgage loans made to the borrower 15 or may sub-service this out to another party. Servicing a reverse mortgage loan may include any activities which are conventional to the service of a loan (e.g., tracking the accrual of interest).

Securitization component 30 securitizes the reverse mortgage loan and sells the securitized notes to one or more investor components 40. This sale of the securitized notes, which may be based on one or more reverse mortgage loans, enables lender component 20 to achieve financial liquidity in exchange for the reverse mortgage loans. Financial guarantor component 50 may provide a financial guarantee on the securitized notes, thereby ensuring a return on investment for purchases of the securitized notes.

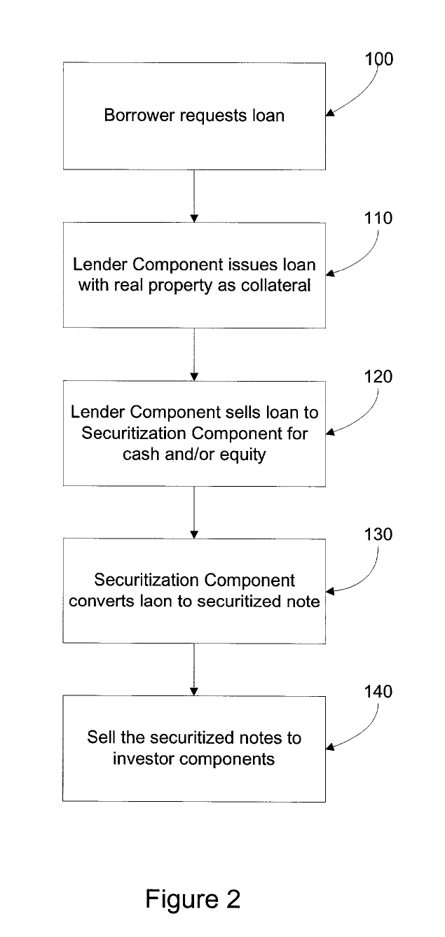

FIG. 2 is a flowchart illustrating a process for issuing and securitizing a reverse mortgage loan according to an embodiment of the invention. While this process will be described in connection with the system of FIG. 1, it is understood that other systems may be used to implement this process. At step 100, a borrower 15 (e.g., a homeowner) requests a reverse mortgage loan from lender component 20.

At step 110, lender component 20 issues the reverse mortgage loan to the borrower 15. In exchange for the reverse mortgage loan, borrower 15 pledges an asset, such as real property or a home, as collateral. At step 120, lender component 20 sells the reverse mortgage loan to securitization component 30. According to an embodiment of the invention, the sale of one or more reverse mortgage loans may be in exchange for cash and/or an equity interest in the securitized notes or loans. By way of example, an equity interest represents the cash flows from the reverse mortgage loans which exceed payments of the securitization component 30 to the securitized note holders.

At step 130, securitization component 30 converts one or more reverse mortgage loans into one or more securitized notes. According to an embodiment of the invention, one or more reverse mortgage loans may be converted into one or more securitized notes (e.g., one reverse mortgage loan per one securitized note, 10,000 reverse mortgage loans per one securitized note, etc.). The process of securitizing the reverse mortgage loans may be performed in any manner known to one of ordinary skill in the art.

Securitization component 30 sells the securitized notes to investor components 40 at step 140. In exchange for the securitized notes, securitization component 30 may receive other considerations. Securitizing the reverse mortgage loans may enable lender component 20 to offer the securitized notes as an investment vehicle to investor component 40 while obtaining liquid assets for the reverse mortgage loans.

As described above, borrower 15 may receive a reverse mortgage loan in exchange for pledging an asset, such as a home, as collateral. According to an embodiment of the invention, borrower 15 is not required to repay the reverse mortgage loan until the loan becomes due, such as when the asset is sold, or is otherwise triggered. By way of example, borrower 15 may pledge a home as collateral for a reverse mortgage loan, where lender component 20 agrees that borrower 15 does not have to repay the reverse mortgage loan until the home is sold. The borrower 15 may repay the reverse mortgage loan from the proceeds of the sale of the home. According to an embodiment of the invention, borrower 15 (e.g., the homeowner or an owner of the real property) may pledge his/her property as collateral for the reverse mortgage loan and agree to repay the reverse mortgage loan from the proceeds of the sale of the home upon the death of the borrower 15. This aspect of the present invention, may enable borrower 15, such as a person at retirement, to access the equity in his/her home without having to sell it.

As described above, an embodiment of the present invention provides a reverse mortgage loan to a borrower 15, with an interest in real property, such as a home and/or land, as collateral. Repayment of the reverse mortgage loan may be made either directly by the borrower 15 (e.g., by a cash repayment), or if the borrower 15 dies, out of the proceeds of the sale of the real property. According to an embodiment of the invention, no installment payments of interest and/or principal are required for the reverse mortgage loan until a full payment of the principal amount of the reverse mortgage loan and the accrued interest on the principal (i.e., the payoff amount of the reverse mortgage loan) is made. As described above, repayment of the payoff amount may be based on one or more repayment calculation components. In one example of an embodiment of the present invention, a first repayment calculation component is used for one time period, a second repayment calculation component is used for a second time period, and a third repayment calculation component is used for a third time period. Various types of repayment calculation components may be used, including, but not limited to, a flat repayment calculation component, a roll-up repayment calculation component, a compounded interest repayment calculation component, a loan plus change in an index value repayment calculation component, and/or other types of repayment calculation components.

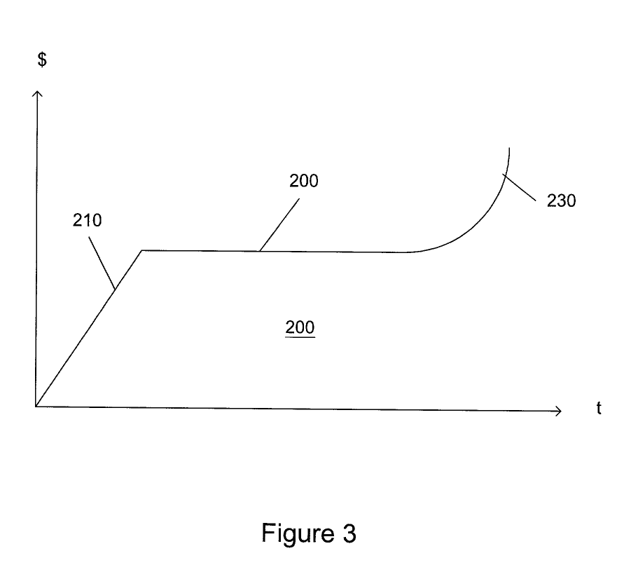

According to an embodiment of the invention, the amount of repayment for a reverse mortgage loan may vary depending on when the reverse mortgage loan is repaid. According to an embodiment of the invention, the repayment schedule 200 may be calculated using a plurality of repayment calculation components. FIG. 3 illustrates a repayment schedule 200 according to an embodiment of the invention. The repayment schedule 200 includes three (3) different repayment components, where a repayment amount is calculated differently depending upon the time of repayment. As illustrated in FIG. 3, the horizontal axis of the graph represents the time from the date the reverse mortgage loan was made, while the vertical axis represents the repayment amount. The first repayment calculation component 210, as illustrated in the example of FIG. 3, is a simple interest calculation. By way of example only, a homeowner receives a reverse mortgage loan in the amount of fifty thousand dollars ($50,000). The first repayment calculation component 210 is a simple interest calculation of eighty percent (80%) for a time period of four (4) years. Thus, the homeowner has to repay an additional twenty percent (20%) each year. If the homeowner sells his/her home at year 3, the homeowner must pay the $50,000 principal of the reverse mortgage loan, as well as a total of sixty percent (60%) or $30,000. Thus, payoff amount the reverse mortgage loan at year three would be $80,000.

As further illustrated in FIG. 3, the second repayment calculation component 220 is a flat repayment, where the repayment amount does not increase during the time period. Further to the example above, the second repayment calculation component may cover the time period from year 4 until year 20. If the reverse mortgage loan is repaid at any time from year 4 to year 20, the borrower pays $90,000 ($50,000+($50,000×80%)), regardless of whether it is repaid at year 4 or at year 20, or at any time in between.

A third repayment calculation component 230 may cover any time after 20 years from the date the reverse mortgage loan was made. As illustrated in FIG. 3, the third repayment calculation component is a compound interest calculation. By way of continuing the example above, the third repayment calculation 230 may be a seven percent (7%) interest rate compounded yearly. If repayment of the reverse mortgage loan occurs at year 25, the repayment amount is calculated at $90,000, with a seven percent (7%) compound interest calculation over the next five (5) years, thereby generating a total repayment of $126,230. It is understood that any combination and/or number of repayment calculation components may be used in a repayment schedule for a reverse mortgage loan.

The determination by the lender of what interest rates and amounts to loan when making a reverse mortgage loan may vary according to a number of factors. According to an embodiment of the invention, a reverse mortgage loan may be most commonly repaid upon the death of the borrower. In such situations, the mortality rates associated with the borrower (e.g., actuarial table information on the life expectancy) may be considered when making the reverse mortgage loan. In addition, interest parameters, expenses such as legal fees determining the value of the home, administration expenses, marketing, compliance requirements, and other sort of expenses may be factored when determining what amount to loan. Another factor to consider may include the potential for negative equity. That is, the potential for depreciation of the home may be considered to mitigate loss due to such negative equity. By way of example, a homeowner obtains a reverse mortgage loan in the amount of $50,000 and pledges a home appraised at $80,000 as collateral. Upon the death of the homeowner, the repayment amount may be calculated to be $80,000 but the value of the home may have fallen to $70,000, thereby creating a negative equity amount. A lender may mitigate this risk by ensuring that the anticipated final repayment amount is no greater than eighty percent (80%) of the current value of the home. Other valuation amounts may also be used to mitigate such risks.

According to an embodiment of the invention, a borrower may substitute collateral in the reverse mortgage loan (e.g., replacing one piece of real property acting as collateral for a reverse mortgage loan with another piece of real property to act as collateral for that same reverse mortgage loan). By way of example, a borrower may secure a reverse mortgage loan with a home. Later, the borrower sells the home and purchases another home with approximately the same value. As repaying the reverse mortgage loan from the sale of the first home would require the borrower to pay both the principal amount and the accrued interest, the borrower may elect to use the new home to secure the existing reverse mortgage loan, thereby substituting the new home for the previous home as collateral for the reverse mortgage loan.

As also described above, a lender component may decide to securitize a reverse mortgage loan, thereby obtaining liquidity for an asset. According to an embodiment of the invention, the lender component may use pricing and structure models for securitizing a plurality of the reverse policy loans. A pricing model may provide pricing parameters for securitization notes based on the reverse policy loans. A structure model may specify a securitization structure (e.g., securitization note components, what entities perform what duties within a securitization note, what entities are involved, the relationship between entities, etc.). Other pricing models and structure models may also be used.

According to an embodiment of the invention, cash waterfalls through a securitization component (which may be a special purpose vehicle for securitizing the reverse mortgage loans) are analyzed. Reverse mortgage loans may be credit-enhanced through a financial guarantee (e.g., letters of credit, servicer advance, etc.), an over-collateralization mechanism or a mortgage indemnity guarantee (MIG) premium, thereby enhancing the value of securitized notes based on these reverse mortgage loans. Over-collateralization may comprise ensuring that the collateral for a reverse mortgage loan is a predetermined amount or percentage greater than the reverse mortgage loan amount. By way of example, all collateral for a reverse mortgage loan may be required to have a value equal to 120% of the expected payoff amount of the reverse mortgage loan. A MIG premium may be used as insurance for any deficit in the value of the collateral and the payoff amount of the reverse mortgage loan. By way of example only, in reference to the system of FIG. 1, financial guarantor component 50 may receive MIG premiums and insure the securitized notes. Other manners of enhancing the credit of a reverse mortgage loan may also be used.

A securitization component (e.g., a special purpose vehicle (SPV) component) may pay a premium for the credit-enhancement. The securitization component may be reimbursed for any losses, such as reverse mortgage loan default losses. The securitization component may pay equity holders when or after the securitized note(s) is paid off. According to an embodiment of the invention, securitization of reverse mortgage loans may be embedded within the reverse mortgage loan product, thereby providing efficient use of capital associated with the reverse mortgage loan.

According to an embodiment of the invention, an optimization aspect of the invention provides for optimizing returns on reverse mortgage loans and securitized reverse mortgage loans, thereby generating an expected return structure (e.g., underwriting and pricing). The expected return structure may correspond to monetary returns expect from an issued reverse mortgage loan. An optimization aspect may be subject to certain information and constraints, such as borrower information, optimization constraints, solver constraints, and other information and constraints. Borrower information may include any information about the borrower, such as credit history, age, sex, income, marital status, job history, and other information. According to an embodiment of the invention, actuarial computations may be involved. By way of example, when issuing a reverse mortgage loan to be repaid upon the death of the borrower, mortality vectors may be computed to assist in determining the expected return structure.

Optimization constraints may include information related to the expected return on the reverse mortgage loan and the resulting securitized note. Optimization constraints may include loss thresholds, cashflow requirements, return on equity, return on investment, return on capital, loans to value, expectations on future real estate values and other constraints. Other optimization constraints may also be used.

Solver constraints include information related to mathematical calculations of the expected return structure and constraints on these calculations. Solver constraints may include a maximum time for optimizing the expected return structure, the number of iterations performed, tolerance levels, precision levels, convergent levels, tangential or quadratic estimates, forward or central derivatives, Newton or conjugate searches, assumptions regarding a linear model or non-negative values, using automatic scaling, and other constraints. According to an embodiment of the invention, optimization may include using a solver function found on a spreadsheet, such as Microsoft Excel®, where options for selecting solver constraints are presented by the spreadsheet.

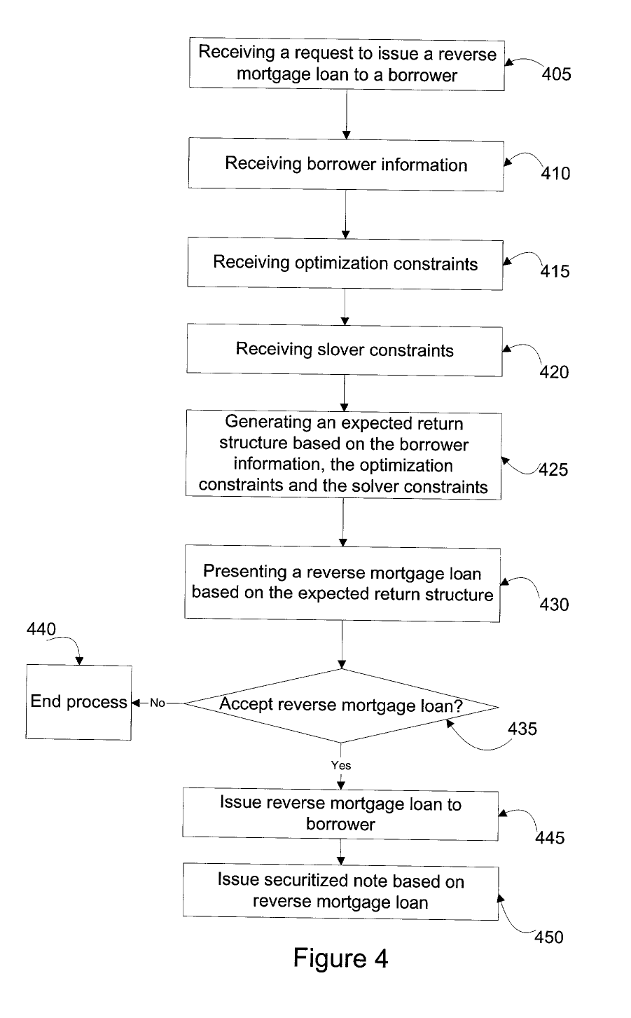

FIG. 4 illustrates a flowchart for optimizing an expected return structure according to an embodiment of the invention. At step 405, a request to issue a reverse mortgage loan to a borrower is received. The request may be made in any conventional manner, such as a borrower at a bank or financial institution, via a telephone request, via an internet request (e.g., input in a web site) or other type of request.

At step 410, borrower information is received. Optimization constraints are received at step 415, and solver constraints are received at step 420. Borrower information, optimization constraints, and solver constraints are described in greater detail above. At step 425, an expected return schedule is generated based at least in part on the borrower information, the optimization constraints, and the solver constraints. At step 430, a reverse mortgage loan based on the expected return schedule is presented to the borrower. The borrower may determine whether to accept the reverse mortgage loan at step 435.

If a borrower decides not to accept the reverse mortgage loan, the process may end at step 440. If the borrower decide to accept the reverse mortgage loan, the reverse mortgage loan is issued at step 445. At step 450, a securitized note based on the reverse mortgage loan is issued. The securitized note may be issued as described above in greater detail. It is understood that the aforementioned process may be performed with steps omitted, steps added, and/or steps in a different order.

A company using securitization component 30 may receive purchased reverse mortgage loans, and may treat the loans as assets. According to an embodiment of the invention, securitization component 30 may cause securitization note(s) to be issued based on and backed by reverse mortgage loans. Actuarial computations embodied, for example, in computer programs, enable the issuer and purchaser of the securitization to project appropriately principal payments to be made on the securitization note. A computer program may include standard actuarial methods known to those in the actuarial art.

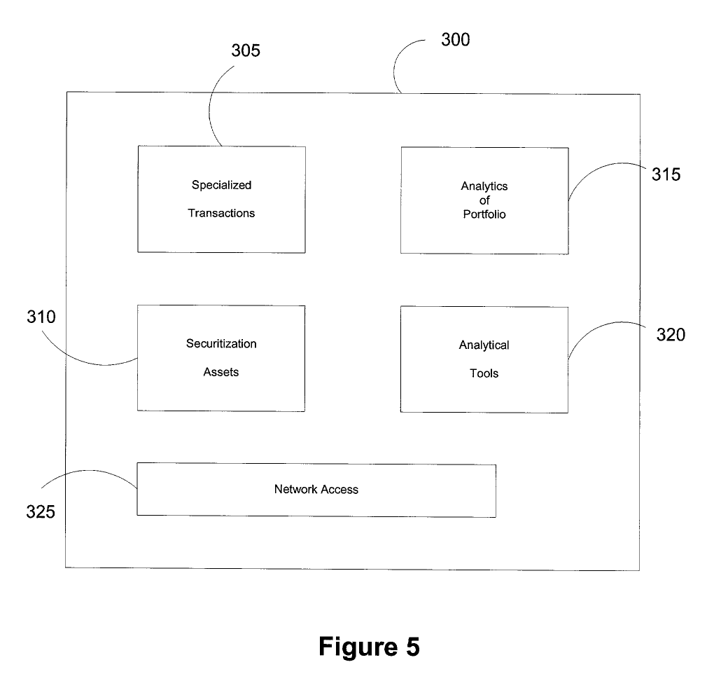

FIG. 5 illustrates one possible overall structure for a graphic user interface 300 that may be presented to a user for optimization and securitization of reverse mortgage loans. According to an embodiment of the invention, graphic user interface 300 may be presented to a user of securitization component 30. Graphic user interface 300 presents various information and tools to a user, where the information and tools may relate to management of securitized reverse mortgage loans, as well as other assets. However, graphic user interface 300 may be used in connection with other components of the system.

According to an embodiment of the invention, graphic user interfaces may display specialized transactions 305, securitization assets 310, portfolio 315, tools 320, and network access 325. Specialized transactions 305 may provide information about special financial transactions, including asset information, such as the current value of the assets, and the asset performance. Specialized transactions may include transactions with certain tax implications, ownership implications, or other predetermined implications to a securitization component 30.

Securitization assets 310 may provide information about general securitization assets, including reverse mortgage policy loans. Information may include the cash flow of the asset, mortality vectors, and the collateral associated with the asset. Thus, in the context of securitization of reverse mortgage loans, information may include the beginning of the reverse mortgage loan balance, the current reverse mortgage loan balance, the interest accrued, and the expected return structure of the reverse mortgage loan. Other information may also be presented.

Portfolio 315 may present information about a current portfolio of assets, including securitized reverse mortgage loans. Information may include the current cash flow of the assets, the value of the assets, the performance of the assets relative to alternatives, and other information. According to an embodiment of the invention, portfolio 315 may present information about a portfolio of reverse mortgage loans, including the cash flow and value of the loans, the rate of return on the securitized reverse mortgage loans in comparison to U.S. Treasury bills, UK gilts, or other investment benchmarks, the aggregate value of reverse mortgage loans, the amount repaid due to mortality and other information. Other information may also be presented by portfolio 315.

Tools 320 may present a user with tools to analyze various assets for securitization, including reverse mortgage loans. Tools 320 may allow a user to create various scenarios with a particular asset and determine cash flow, performance, and value of the asset based on the scenario. According to an embodiment of the invention, tools 320 may permit a user to determine the cash flow and value of a securitization of a reverse mortgage loan based on various factors, including the length of the loan, mortality, and other factors. Tools 320 may also present other tools.

Network access 325 may allow a user to access various network connections. Network connections may include the internet, an intranet, dial-up connections, satellite networks, or other connections between securitization processing component 40 and other components or other systems. Network access 330 may permit a user to interact with other computers and perform various activities associates with collection of payments, payment of taxes, auditing records, monitor transactions, and provide information. Other interaction and activities may also be performed.

Other embodiments of graphic user interface 300 may also used, either in connection with securitization component 30, or with other components of the system. Other configurations, information, tools, and applications may also be associated with graphic user interface 300.

Creating a securitization note from the reverse mortgage loans may allow a company to issue commercial paper based on the securitization note, and accordingly on the reverse mortgage loans, and may be counted on to provide funding at prevailing highly rated debt securities interest rates. Issuing commercial paper may provide a vehicle for reverse mortgage loans to have enhanced liquidity and broader market acceptance. According to an embodiment of the invention, reverse mortgage loans may be sold using the present invention and replaced with other liquid assets, such as U.S. Treasury bonds, U.K. gilts, or other assets appropriate for the investment of a company's reserves. These sales may increase liquidity.

Securitization of reverse mortgage loans may enable reverse mortgage loans to be more easily bought and sold. According to an embodiment of the invention, reverse mortgage loans may be offered to borrowers, by a lender, such as a bank or other financial institution.

According to another embodiment of the invention, a computer usable medium having computer readable program code embodied therein for an electronic computation may be provided. For example, the computer usable medium may comprise a CD ROM, a floppy disk, a hard disk, or any other computer usable medium. One or more of the components of the system may comprise computer readable program code that is provided on the computer usable medium such that when the computer usable medium is installed on a computer system, those components cause the computer system to perform the functions described.

According to one embodiment, various components used in a system and process of the present invention may use or comprise computer readable code that, when installed on a computer, perform the functions described above. Also, only some of the components may be provided in computer readable code.

Additionally, various entities and combinations of entities may employ a computer to implement the components performing the above described functions. According to an embodiment of the invention, a computer may be a standard computer comprising an input device, an output device, a processor device, and a data storage device. According to other embodiments of the invention, various components may be different department computers within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, a system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A process for providing a loan secured by real property comprising the steps of:
issuing a lump sum loan amount to an individual with an interest in real property, the loan secured by the real property of the individual and having a principal amount, an interest amount and a payoff amount where the individual does not make any installment payment toward repayment of the principal amount or towards repayment of the interest amount accrued until a termination date of the loan; and
receiving a payment corresponding to the payoff amount of the loan on the termination date of the loan, the payoff amount being equal to the principal amount and the interest amount accrued during a term of the loan, and where the interest amount accrued is calculated based on a repayment schedule having at least one repayment calculation component.

2. The process according to claim 1, wherein the termination date of the loan is based on a date of the death of the individual.

3. The process according to claim 1, wherein the termination date of the loan is based on a date when the real property is sold by the individual.

4. The process according to claim 1, wherein the repayment schedule comprises a plurality of calculation components.

5. The process according to claim 1, wherein the repayment schedule comprises three repayment calculation components comprising:
a) a simple interest repayment calculation component;
b) a no additional interest repayment calculation component; and
c) a compound interest repayment calculation component.

6. The process according to claim 1, further comprising the step of issuing a second lump sum loan to the individual using the real property as security for the second lump sum loan, wherein an amount of the second lump sum loan is based on an increase in a value of the real property.

7. The process according to claim 1, wherein the repayment schedule is based on a plurality of standard actuarial tables and a life expectancy of the individual.

8. A process for providing a loan secured by an asset comprising the steps of:
issuing a lump sum loan amount to an owner of an asset, the loan secured by the asset of the owner and having a principal amount, an interest amount and a payoff amount where the owner does not make an installment payment toward repayment of the principal amount towards repayment of the interest amount accrued until a termination date of the loan; and
receiving a payment corresponding to the payoff amount of the loan on the termination date of the loan, the payoff amount being equal to the principal amount and the interest amount accrued during a term of the loan, and where the interest amount accrued is calculated based on a repayment schedule having a plurality of repayment calculation components.

9. The process according to claim 8, wherein the termination date of the loan is based on a date of the death of the owner.

10. The process according to claim 8, wherein the termination date of the loan is based on the date when the asset is sold by the owner.

11. The process according to claim 8, wherein the repayment schedule comprises three repayment calculation components comprising:
a) a simple interest loan repayment calculation component;
b) a no additional interest repayment calculation component; and
c) a component interest repayment calculation component.

12. The process according to claim 8, further comprising the step of issuing a second lump sum loan to the owner using the asset as security for the second lump sum loan, wherein an amount of the second lump sum loan is based on an increase in the value of the asset.

13. The process according to claim 8, wherein the repayment schedule is based on a plurality of standard actuarial tables and a life expectancy of the owners.

14. A system for providing a loan secured by real property, the loan having a principal amount, an interest amount and a payoff amount, the system comprising:
at least one borrower receiving at least one lump sum loan amount, where the loan is secured by the real property of the at least one borrower, and the at least one borrower does not make any installment payment toward repayment of the principal amount, or toward repayment of the interest amount accrued until a termination date of the loan; and
at least one lender component issuing the at least one lump sum loan amount and receiving a payment corresponding to the payoff amount of the loan on the termination date of the loan, the payoff amount being equal to the principal amount and the interest amount accrued during a term of the loan, and wherein the amount accrued is calculated based on a repayment schedule having at least one repayment calculation component.

15. The system according to claim 14, where the termination date of the loan is based on a date of the death of the owner.

16. The system according to claim 14, where the termination date of the loan is based on a date when the real property is sold by the borrower.

17. The system according to claim 14, where the repayment schedule comprises a plurality of repayment calculation components.

18. The system according to claim 14, where the repayment schedule comprises three repayment calculation components comprising:
a) a simple interest repayment calculation component;
b) a no additional interest repayment calculation component; and
c) a compound interest repayment calculation component.

19. A system for providing a loan secured by an asset, the loan having a principal amount, an interest amount, and a payoff amount, the system comprising:
at least one borrower receiving at least one lump sum loan amount, where the loan is secured by the asset of the at least one borrower, and the at least one borrower does not make any installment payment toward repayment of the principal amount or toward repayment of the interest amount accrued until a termination date of the loan; and
at least one lender component issuing the at least one lump sum loan amount and receiving a payment corresponding to the payoff amount of the loan on the termination date of the loan, the payoff amount being equal to the principal amount and the interest amount accrued during a term of the loan, and wherein the amount accrued is calculated based on a repayment schedule having a plurality of repayment calculation components.

20. The system according to claim 14, where the termination date of the loan occurs on a date of the death of the owner.

21. The system according to claim 14, where the termination date of the loan occurs on a date when the real property is sold by the borrower.

22. The system according to claim 14, where the repayment schedule comprises three repayment calculation components comprising:
a) a simple interest repayment calculation component;
b) a no additional interest repayment calculation component; and
a compound interest repayment calculation component.

23. A system for securitizing a loan having a principal amount, an interest amount and a payoff amount, the system comprising:
a lender component for issuing at least one loan secured by real property to a borrower, wherein:
a) no installment payment towards repayment of the principal amount or toward repayment of the interest amount accrued is required until a termination date of the at least one loan;
b) the payoff amount is equal to the principal amount and the interest amount accrued during a term of the at least one loan; and
c) the interest amount accrued during the term of the loan is calculated based on a repayment schedule having a plurality of repayment calculation components; and
a securitization component for issuing at least one securitized note based on the at least one loan.

24. The system according to claim 23, where the at least one securitized note is issued based on actuarial computations involving the mortality of the borrower.

25. The system according to claim 23, where the lender component issues an incremental addition to the at least one loan and an increase in the value of the real property secures the incremental addition to the at least one loan.

26. The system according to claim 25, where the securitization component issues at least one additional securitized note based on the incremental addition to the at least one loan.

27. A process for securitizing a loan having a principal amount, an interest amount and a payoff amount, the process comprising:
issuing at least one loan to a borrower where:
a) the at least one loan is secured by real property;
b) no installment payment toward repayment of the principal amount or toward repayment of the interest amount accrued is required until a termination date of the at least one loan; and
c) the amount accrued during the term of the loan is calculated based on a repayment schedule having a plurality of repayment calculation components; and
issuing at least one securitized note based on the at least one loan.

28. The process according to claim 27, where the at least one securitized note is issued based on actuarial computations involving the mortality of the borrower.

29. The process according to claim 27, further comprising the step of issuing an incremental addition to the at least one loan, where an increase in the value of the real property secures the incremental addition to the at least one loan.

30. The process according to claim 29, further comprising the step of issuing at least one additional securitized note based on the incremental addition to the at least one loan.

31. A process for optimizing an expected return structure on a loan and at least one securitized note based on the loan, the loan having a principal amount, an interest amount, and payoff amount, the process comprising:
receiving borrower information, where the borrower information comprises information related to a borrower receiving the loan;
receiving optimization constraints, where the solver constraints comprise information related to mathematical calculations of the expected return structure;
receiving solver constraints, where the solver constraints comprise information to mathematical calculations of the expected return structure; and
generating the expected return structure based in part on the borrower information, the optimization constraints and the solver constraints.

32. The process according to claim 31, further comprising the step of issuing the loan to the borrower, where the loan is based on the expected return structure.

33. The process according to claim 31, where the step of generating the expected return structure is further based on the actuarial computations, including mortality vectors, based on the borrower information.

34. The process according to claim 31, where the optimization constraints further comprise at least one of:
a) loss thresholds;
b) cashflow requirements;
c) return on equity;
d) return on investment;
e) return on capital; and
f) expectations of further real estate prices.

35. The process according to claim 31, where the loan is secured by real property.

36. The processing according to claim 32, further comprising the step of issuing at least one securitized note based on the loan.

37. The process according to claim 32, where:
a) no installment payments toward repayment of the principal amount or toward repayment of the interest amount accrued is required until a termination date of the loan;
b) the payoff amount is equal to the principal amount and the interest amount accrued during a term of the loan; and
c) the interest amount accrued during the term of the loan is calculated based on a repayment schedule having a plurality of repayment calculation components.

38. The process according to claim 37, further comprising the step of issuing at least one securitized note based on the loan.

39. The process according to claim 31, where the solver constraints further comprise at least one of:
a) a maximum time for calculating the expected return structure;
b) a number of iterations to be performed;
c) a precision level;
d) a tolerance level;
e) a convergent level;
f) a tangential estimate;
g) a quadratic estimate;
h) a designation to use either a forward derivative or a central derivative;
i) a designation to use either a Newton search or a conjugate search;
j) automatic scaling; and
k) an assumption regarding a linear model.

40. A system for optimizing an expected return structure on a loan and at least one securitized note based on the loan, the loan having a principal amount, an interest amount and a payoff amount, the system comprising:
a receiver module for receiving:
a) borrower information related to a borrower receiving the loan;
b) optimization constraints comprising information related to the expected return structure; and
c) receiving solver constraints comprising information relate to the mathematical calculations for arriving at the expected return structure; and
a processor module for generating the expected return structure based in part on the borrower information, the optimization constraints and the solver constraints.

41. The system according to claim 40, further comprising a lender component for issuing the loan to the borrower, where the loan is based on the expected return schedule.

42. The system according to claim 40, where the step of generating the expected return structure is further based on the actuarial computations, including mortality vectors, based on the borrower information.

43. The system according to claim 40, where the loan is secured by real property.

44. The system according to claim 40, where optimization constraints further comprise at least one of:
a) loss thresholds;
b) cashflow requirements;
c) return on equity;
d) return on investments;
e) return on capital; and
f) expectations of further real estate prices.

45. The system according to claim 41, wherein:
a) no installment payment toward repayments of the principal amount or toward repayment of the interest amount accrued is required until a termination date of the loan;
b) the payoff amount is equal to the principal amount and the interest amount accrued during a term of the loan; and
c) the interest amount accrued during the term of the loan is calculated based on a repayment schedule having a plurality of repayment calculation components.

46. The system according to claim 45, further comprising a securitization component for issuing at least one securitized note based on the loan.

47. The system according to claim 41, further comprising a securitization component for issuing at least one securitization note based on the loan.

48. The system according to claim 40, where the solver constraints further comprise at least one of:
a) a maximum time for calculating the expected return structure;
b) a number of iterations to be performed;
c) a precision level;
d) a tolerance level;
e) a convergent level;
f) a tangential estimate;
g) a quadratic estimate;
h) a designation to use either a forward derivative or a central derivative;
i) a designation to use either a Newton search or a conjugate search;
j) automatic scaling; and
k) an assumption regarding a linear model.
